(19) United States
(12) Patent Application Publication
(10) Pub. No.: US 2023/0207944 A1
(43) Pub. Date: Jun. 29, 2023

(54) MOVING BODY

(71) Applicant: HONDA MOTOR CO., LTD., Tokyo (JP)

(72) Inventor: Ken YASUI, Saitama (JP)

(73) Assignee: HONDA MOTOR CO., LTD., Tokyo (JP)

(21) Appl. No.: 18/087,168

(22) Filed: Dec. 22, 2022

(30) Foreign Application Priority Data
Dec. 27, 2021 (JP) 2021-213000

(51) Int. Cl. H01M 50/249; H01M 50/276; H01M 10/6556; H01M 10/6568; B60R 16/04

(52) U.S. Cl. CPC H01M 50/249; H01M 50/276; H01M 10/6556; H01M 10/6568; B60R 16/04; H01M 2220/20

(57) ABSTRACT

A moving body includes a floor panel, and a battery pack disposed below the floor panel. The battery pack includes a battery, a battery case having an opening on an upper side and accommodating the battery, a battery cover covering the opening of the battery case, and a temperature adjustment mechanism provided in the battery cover. A gap is provided at least either between the battery and a bottom surface of the battery case or between an under guard provided below the bottom surface of the battery case and the bottom surface of the battery case.

### CROSS-REFERENCE TO RELATED APPLICATIONS

This application is based on and claims priority under 35 USC 119 from Japanese Patent Application No. 2021-213000 filed on Dec. 27, 2021.

### TECHNICAL FIELD

The present disclosure relates to a moving body mounted with a battery pack.

### BACKGROUND ART

In recent years, as a specific measure against global climate change, efforts for realizing a low-carbon society or a decarbonized society have become active. Also in moving bodies such as vehicles, a reduction in CO₂ emission amount has been strongly required, and a drive source has been rapidly electrified. Specifically, a vehicle including an electric motor as a drive source of the vehicle and a battery as a secondary battery capable of supplying an electric power to the electric motor, such as an electrical vehicle or a hybrid electrical vehicle, has been developed.

When the battery is used at a temperature outside a predetermined temperature range, a function of the battery cannot be sufficiently exhibited or the battery is easily deteriorated, and thus temperature adjustment is necessary. For example, JP 2018-105573 A describes cooling a battery by externally bringing a cooling mechanism into contact with a bottom surface of a battery case.

However, as described in JP 2018-105573 A, when the battery case with the cooling mechanism disposed on the bottom surface of the battery case is provided below a floor panel of a vehicle, the cooling mechanism may be damaged by an impact from a bottom surface of the vehicle caused by a road curb or a protrusion such as a stone or rock. In addition, it is naturally necessary to protect the battery against impact from the bottom surface of the vehicle.

### SUMMARY

The present disclosure provides a moving body capable of preventing damage to a battery and a temperature adjustment mechanism for the battery.

According to an aspect of the present disclosure, there is provided a moving body, including: a floor panel; and a battery pack disposed below the floor panel, in which the battery pack includes: a battery; a battery case having an opening on an upper side and accommodating the battery; a battery cover covering the opening of the battery case; and a temperature adjustment mechanism provided in the battery cover, and a gap is provided at least either between the battery and a bottom surface of the battery case or between an under guard provided below the bottom surface of the battery case and the bottom surface of the battery case.

According to the present disclosure, the damage to the battery and the temperature adjustment mechanism for the battery can be avoided even when an impact is received from a bottom side of the moving body.

### BRIEF DESCRIPTION OF DRAWINGS

FIG. 1 is a side view schematically illustrating a vehicle 1 mounted with a battery pack 60.

FIG. 2 is a plan view of the battery pack 60.

FIG. 3 is a cross-sectional view of the battery pack 60 according to an embodiment taken along line A-A in FIG. 2.

FIG. 4 is a cross-sectional view of the battery pack 60 according to a modification taken along line A-A in FIG. 2.

### DESCRIPTION OF EMBODIMENTS

A moving body according to the present disclosure will be described by taking a vehicle as an example and referring to the drawings, it should be noted that the drawings should be viewed in a direction of reference numerals, and in the following descriptions, front, rear, left, right, upper, and lower are described according to a direction viewed from an operator of the vehicle. In the drawings, front, rear, left, right, upper, and lower sides of the vehicle are represented by Fr, Rr, L, R, U, and D, respectively.

### Vehicle

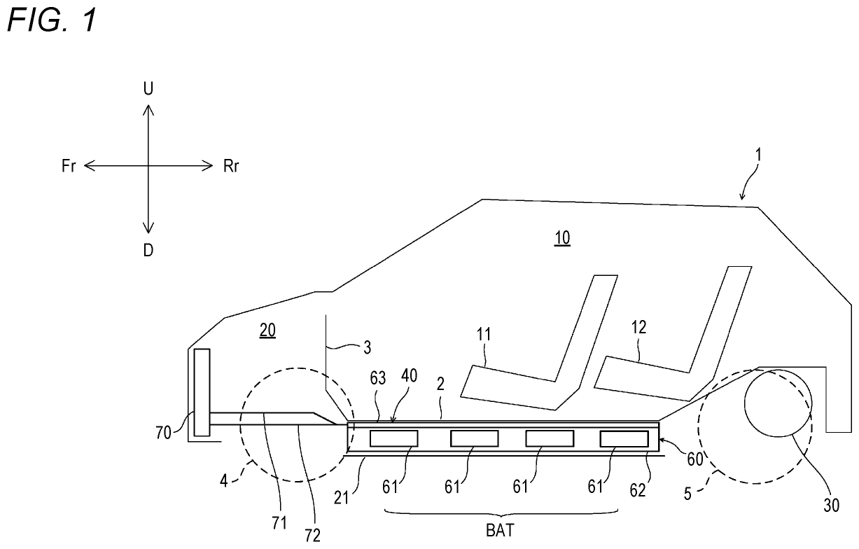

As illustrated in FIG. 1, a vehicle 1 according to an embodiment of the present disclosure is partitioned into a passenger compartment 10 and a front room 20 in front of the passenger compartment 10 by a floor panel 2 and a dash panel 3. The passenger compartment 10 is provided with a front seat 11 and a rear seat 12. A motor 30 as a drive source is provided below the floor panel 2 behind the rear seat 12. The motor 30 drives left and right rear wheels 5. That is, in the vehicle 1, the left and right rear wheels 5 are used as drive wheels, and left and right front wheels 4 are used as driven wheels. It should be noted that the vehicle 1 may be a front wheel drive vehicle or a four-wheel drive vehicle.

A battery pack 60 is disposed below the passenger compartment 10. The battery pack 60 accommodates a battery BAT and is disposed below the floor panel 2 in passenger compartment 10. A plate-shaped under guard 21 which covers, from below, a bottom surface 62a of a battery case 62, which will be described later, is provided below the battery pack 60, that is, below the bottom surface 62a of the battery case 62.

A radiator 70 is provided in the front room 20. The radiator 70 is connected through a supply pipe 71 and a discharge pipe 72 to a temperature adjustment mechanism 40 which adjusts a temperature of the battery BAT, which will be described later. A liquid medium (hereinafter referred to as refrigerant) circulates in a circulation channel formed by the radiator 70, the supply pipe 71, the temperature adjustment mechanism 40, and the discharge pipe 72. It should be noted that an electric pump (not illustrated) is provided on the supply pipe 71 or the discharge pipe 72.

### Battery Pack

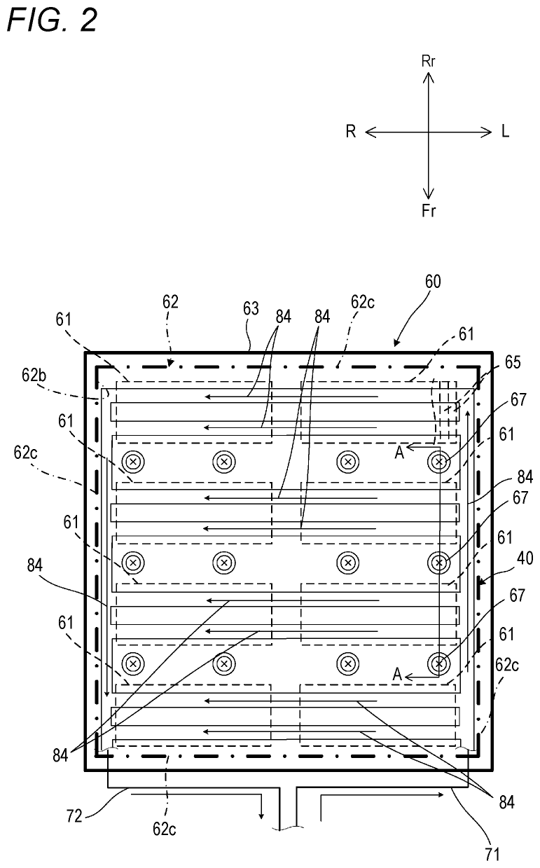

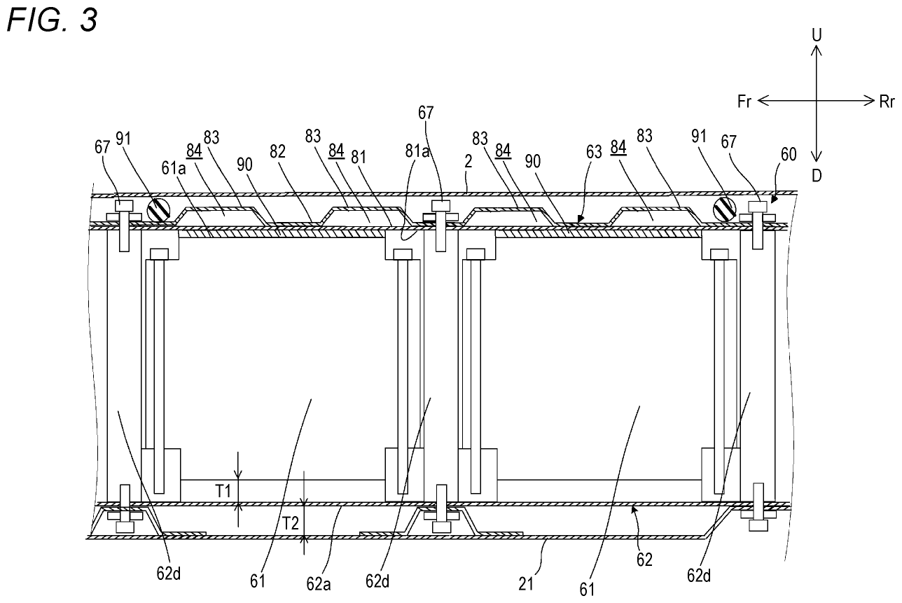

Next, the battery pack 60 and the temperature adjustment mechanism 40 thereof will be described with reference to FIGS. 2 and 3.

The battery pack 60 includes the battery BAT, the battery case 62 having an opening 62b on an upper side and accommodating the battery BAT, a battery cover 63 covering the opening 62b of the battery case 62, and the temperature adjustment mechanism 40 provided in the battery cover 63.

### Battery

The battery BAT includes a plurality of battery modules 61. The battery BAT according to the present embodiment includes a total of eight battery modules 61 arranged four in each column in the front-rear direction and two in each row in the left-right direction. It should be noted that the number and arrangement of the battery modules 61 can be appropriately set. In addition, the battery BAT does not necessarily have to be modularized, and it is sufficient that a plurality of battery cells 65 are stacked in the battery case 62. The battery BAT is configured to be able to supply electric power to the motor 30 and receive electric power from the motor 30. A stacking direction of the battery cells 65 may be a vertical direction or a horizontal direction. In the present embodiment, the battery module 61 in which the battery cells 65 are stacked in the left-right direction is illustrated.

### Battery Cell

Each battery cell 65 may be a lithium ion battery, a nickel metal hydride battery, or an all-solid-state battery. In addition, the battery cell 65 may have a pouch shape or a can shape.

### Battery Case

The battery case 62 is formed such that a side wall portion 62c rises from an outer edge of the bottom surface 62a, and the opening 62b is partitioned by an upper end portion of the side wall portion 62c. The side wall portion 62c includes a left wall portion and a right wall portion facing each other in the left-right direction, and a front wall portion and a rear wall portion facing each other in the front-rear direction in addition, in the battery case 62, three side members 62d (see FIG. 3) each connecting the left wall portion and the right wall portion are disposed to be spaced apart from each other in the front-rear direction, and two battery modules 61 disposed in the left-right direction are disposed between the front wall portion and the side member 62d, between the side members 62d, and between the side member 62d and the rear wall portion. In FIGS. 2 and 3, a reference numeral 67 denotes a bolt for fastening the battery cover 63 to the side member 62d of the battery case 62.

### Battery Cover and Temperature Adjustment Mechanism

As illustrated in FIG. 3, the battery cover 63 includes a lower plate 81 covering the opening 62b of the battery case 62 and an upper plate 82 provided above the lower plate 81, and the lower plate 81 and the upper plate 82 are fixed to each other in a sealed state. It should be noted that the battery cover 63 may be a multilayer structure including a plate other than the lower plate 81 and the upper plate 82.

The upper plate 82 is provided with a convex portion 83 in which a portion through which the refrigerant flows is raised upward, and a refrigerant flow channel 84 through which the refrigerant flows is formed between the lower plate 81 and the convex portion 83. A configuration of the refrigerant flow channel 84 can be appropriately set. The battery cover 63 is a lid member having a water jacket.

A heat transfer member 90 is provided between an upper surface 61a of the battery module 61, which is an upper surface of the battery BAT, and a lower surface 81a of the lower plate 81. In other words, the lower surface 81a of the lower plate 81 facing the upper surface 61a of the battery BAT is in contact with the upper surface 61a of the battery BAT through the heat transfer member 90. Accordingly, a temperature adjustment efficiency can be improved, and a height of the battery pack 60 can be reduced. It should be noted that the heat transfer member 90 is not necessarily required, and the upper surface 61a of the battery BAT and the lower surface 81a of the lower plate 81 may be in direct contact. In other words, the lower surface 81a of the lower plate 81 facing the upper surface 61a of the battery BAT may be in direct contact with the upper surface 61a of the battery BAT.

Further, in terms of improving the temperature adjustment efficiency, it is preferable that the lower surface 81a of the lower plate 81 facing the upper surface 61a of the battery BAT has a planar shape. The planar shape means a flat surface with no or little unevenness. Accordingly, a contact area between the battery BAT and the battery cover 63 can be increased, and the temperature adjustment efficiency can be improved. In addition, a wasted space in the battery pack 60 can be reduced. Moreover, it is preferable that the upper surface 61a of the battery BAT also has a planar shape. Therefore, it is preferable that a terminal of the battery cell 65 is not on an upper surface of the battery cell 65, and is present on a front or rear surface or a left or right surface, that is, a surface facing the horizontal direction.

In addition, it is preferable that a sealing member 91 which seals a space between the battery cover 63 and the floor panel 2 is disposed between the battery cover 63 and the floor panel 2. In other words, it is preferable that the battery pack 60 is disposed through the sealing member 91 which seals the space between the battery cover 63 and the floor panel 2. It should be noted that a shape of the sealing member 91 and the number of the seal members 91 can be appropriately set. Since the space between the battery cover 63 and the floor panel 2 is sealed by the sealing member 91, a heat insulation effect can be enhanced, and an influence of outside air on the temperature adjustment mechanism 40 can be restrained.

In the battery pack 60 thus formed, the refrigerant cooled by the radiator 70 is supplied to the refrigerant flow channel 84 of the temperature adjustment mechanism 40 through the supply pipe 71 as indicated by an arrow in FIG. 2. The refrigerant flowing through the refrigerant flow channel 84 cools the battery BAT by exchanging heat with the battery BAT, and returns to the radiator 70 through the discharge pipe 72.

According to the present embodiment, since the temperature adjustment mechanism 40 is provided in the battery cover 63, damage to the temperature adjustment mechanism 40 can be avoided even when an impact is received from a bottom side of the vehicle 1. Meanwhile, when the temperature adjustment mechanism 40 is provided in the battery cover 63, the battery BAT may be damaged when an impact is received from the bottom side of the vehicle 1.

Therefore, in the battery pack 60 according to the present embodiment, a first gap T1 is provided between the battery BAT and the bottom surface 62a, of the battery case 62, and a second gap T2 is provided between the under guard 21 provided below the bottom surface 62a of the battery case 62 and the bottom surface 62a of the battery case 62. It should be noted that either one of the first gap T1 and the second gap T2 may be provided, or both the first gap T1 and the second gap T2 may be provided. Accordingly, even when an impact is received from the bottom side of the vehicle 1, damage to the temperature adjustment mechanism 40 can be avoided, and damage to the battery BAT can be prevented.

### Modification

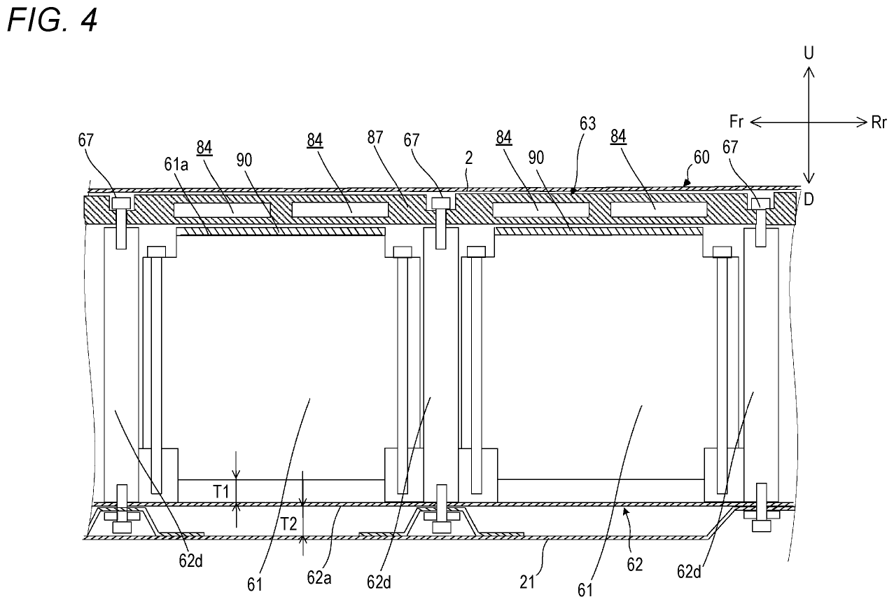

As illustrated in FIG. 4, the battery cover 63 is formed of a cooling plate 87 covering the opening 62b of the battery case 62 and having a predetermined thickness, and the refrigerant flow channel 84 may be formed through the cooling plate 87. Such a cooling plate 87 can be formed by aluminum die casting, for example. With such a cooling plate 87, the temperature adjustment mechanism 40 can be integrally formed with the battery cover 63.

Although various embodiments have been described above with reference to the drawings, it is needless to say that the present invention is not limited to such an example. It will be apparent to those skilled in the art that various changes and modifications can be conceived within the scope of the claims, and it is also understood that the various changes and modifications naturally belong to the technical scope of the present invention. In addition, components in the embodiments described above may be combined freely within a range not departing from the spirit of the invention.

For example, a vehicle is illustrated as the moving body in the embodiments, but the moving body may be a working machine such as a snow removing machine or a lawn mower.

At least the following matters are described in the present specification. It should be noted that although corresponding components or the like in the above embodiments are shown in parentheses, the present invention is not limited thereto.

(1) A moving body (vehicle 1), including:

a floor panel (floor panel 2); and

a battery pack (battery pack 60) disposed below the floor panel, in which

the battery pack includes:
a battery (battery BAT);
a battery case (battery case 62) having an opening (opening 62b) on an upper side and accommodating the battery;
a battery cover (battery cover 63) covering the opening of the battery case; and
a temperature adjustment mechanism (temperature adjustment mechanism 40) provided in the battery cover, and

a gap (first gap T1, second gap T2) is provided at least either between the battery and a bottom surface (bottom surface 62a) of the battery case or between an under guard (under guard 21) provided below the bottom surface (bottom surface 62a) of the batter case and the bottom surface of the battery case.

According to (1), since the temperature adjustment mechanism is provided in the battery cover, damage to the temperature adjustment mechanism can be avoided even when an impact is received from a bottom side of the vehicle. In addition, since the gap is provided at least either between the battery and the bottom surface of the battery case or between the under guard provided below the bottom surface of the battery case and the bottom surface of the battery case, damage to the battery can be prevented even when an impact is received from a bottom surface of the vehicle.

(2) The moving body according to (1), in which

the temperature adjustment mechanism includes a flow channel (refrigerant flow channel 84) which is provided inside the battery cover and through which a liquid medium passes.

According to (2), damage to the water jacket can be avoided.

(3) The moving body according to (2), in which

the battery cover is integrally formed with the flow channel by aluminum die casting.

According to (3), the temperature adjustment mechanism can be integrally formed with the battery cover.

(4) The moving body according to (2), in which

the battery cover includes:
a first plate (lower plate 81) facing an upper surface (upper surface 61a) of the battery, and
a second plate (upper plate 82) which is provided above the first plate and of which a portion corresponding to the flow channel protrudes upward.

According to (4), the temperature adjustment mechanism can be formed in the battery cover with a simple configuration.

(5) The moving body according to any one of (2) to (4), in which

the battery pack is disposed through a sealing member (sealing member 91) which seals a space between the battery cover and the floor panel.

According to (5), since the space between the battery cover and the floor panel is sealed by the sealing member, a heat insulation effect can be enhanced, and the temperature adjustment mechanism can be prevented from being warmed by outside air.

(6) The moving body according to any one of (1) to (5), in which

a lower surface (lower surface 81a) of the battery cover facing an upper surface (upper surface 61a) of the battery is in contact with the upper surface of the battery directly or through a heat transfer member (heat transfer member 90).

According to (6), a temperature adjustment efficiency can be improved, and a height of the battery pack can be reduced.

(7) The moving body according to (6), in which

the lower surface of the battery cover has a planar shape.

According to (7), a contact area between the battery and the battery cover can be increased, and the temperature adjustment efficiency can be improved. In addition, a wasted space in the battery pack can be reduced.

(8) The moving body according to (6) or (7), in which

the battery is formed by stacking a plurality of battery cells (battery cells 65), and

terminals of the battery cells are disposed on a surface facing a horizontal direction perpendicular to a vertical direction.

According to (8), a space between the battery and the battery cover can be eliminated or reduced.

(9) The moving body according to any one of (1) to (8), in which

a first gap (first gap T1) is provided between the battery and the bottom surface of the battery case, and

a second gap (second gap T2) is provided between the under guard (under guard 21) provided below the bottom surface of the battery case and the bottom surface of the battery case.

According to (9), damage to the battery can be further prevented even when an impact is received from the bottom surface of the vehicle.

(10) The moving body according to any one of (1) to (9), in which the battery is an all-solid-state battery.

According to (10), since an all-solid-state battery has a higher heat-resistant temperature than a lithium ion battery or the like, the temperature adjustment mechanism can be miniaturized, and the all-solid-state battery is suitable for providing the temperature adjustment mechanism on the battery cover.

What is claimed is:

1. A moving body, comprising:
a floor panel; and
a battery pack disposed below the floor panel, wherein
the battery pack includes:
a battery;
a battery case having an opening on an upper side and accommodating the battery;
a battery cover covering the opening of the battery case; and
a temperature adjustment mechanism provided in the battery cover, and
a gap is provided at least either between the battery and a bottom surface of the battery case or between an under guard provided below the bottom surface of the battery case and the bottom surface of the battery case.

2. The moving body according to claim 1, wherein
the temperature adjustment mechanism includes a flow channel which is provided inside the battery cover and through which a liquid medium passes.

3. The moving body according to claim 2, wherein
the battery cover is integrally formed with the flow channel by aluminum die casting.

4. The moving body according to claim 2, wherein
the battery cover includes:
a first plate facing an upper surface of the battery; and
a second plate which is provided above the first plate and of which a portion corresponding to the flow channel protrudes upward.

5. The moving body according to claim 2, wherein
the battery pack is disposed through a sealing member which seals a space between the battery cover and the floor panel.

6. The moving body according to claim 1, wherein
a lower surface of the battery cover facing an upper surface of the battery is in contact with the upper surface of the battery directly or through a heat transfer member.

7. The moving body according to claim 6, wherein
the lower surface of the battery cover has a planar shape.

8. The moving body according to claim 6, wherein
the battery is formed by stacking a plurality of battery cells, and
terminals of the battery cells are disposed on a surface facing a horizontal direction perpendicular to a vertical direction.

9. The moving body according to claim 1, wherein
a first gap is provided between the battery and the bottom surface of the battery case, and
a second gap is provided between the under guard provided below the bottom surface of the battery case and the bottom surface of the battery case.

10. The moving body according to claim 1, wherein
the battery is an all-solid-state battery.
